(19) United States
(12) Patent Application Publication
(10) Pub. No.: US 2009/0057584 A1
(43) Pub. Date: Mar. 5, 2009

(54) Lockable Sampling Valve

(75) Inventor: Thomas G. Krulick, Allentown, PA (US)

Correspondence Address: GRAHAM CURTIN, 4 Headquarters Plaza, P.O. Box 1991, Morristown, NJ, 07962-1991, US

(73) Assignee: STRAHMAN VALVES, INC., Bethlehem, PA (US)

(21) Appl. No.: 11/846,532

(22) Filed: Aug. 29, 2007

(51) Int. Cl. F16K 35/00; F16K 31/60

(52) U.S. Cl. 251/101; 251/231

(57) ABSTRACT

A valve comprises a housing, a handle for opening and closing the valve, a handle release that is engagable with the housing to prevent movement of the handle relative to the housing, and that is disengageable from the housing to enable movement of the handle relative to the housing, and a lock for maintaining the handle release engaged with the housing to prevent movement of the handle relative to the housing.

### FIELD OF THE INVENTION

The present invention relates to sampling valves in general, and more particularly to sampling valves that provide for quick sampling and that can be locked in position.

### BACKGROUND

Manually operated piston valves used for draining and sampling materials from vessels traditionally have a hand wheel attached to a threaded stem connected to the piston. The stem turns in a threaded bushing. Rotary motion of the hand wheel causes linear movement of the piston. Typically the stem will have a pitch of six threads per inch, single lead and a 2½″ piston stroke, which would require approximately fifteen turns of the hand wheel to fully open the valve and obtain a sample. An opening indicator in the form of a pointer typically rides on the hand wheel along the threaded stem to indicate the extent of the open position of the piston to the valve operator. Such a scenario is very time-consuming and labor intensive, particularly when it is desired to get samples quickly. Furthermore, the use of such an opening indicator results in an imperfect assessment of the hand wheel relative to the piston head.

In addition, it is often desirable to control access to a sampling valve, or any valve for that matter, and to prevent inadvertent or unauthorized use of the valve. For example, if the material being sampled is proprietary and confidential, or is deemed hazardous to human contact, then it would be desirable to be able to lock the valve so that operation of the valve is limited to authorized users and/or during authorized times. One prior art solution uses a detachable pad lock to prevent the valve handle from moving relative to the valve body. However, pad locks can be removed and/or misplaced, which elevates the risk of future human error and inadvertent and/or unauthorized use.

There is a need, therefore, for a sampling valve that enables quick sampling of material in a secured and controlled environment.

### SUMMARY

A valve comprises a housing, a handle for opening and closing the valve, a handle release that is engagable with the housing to prevent movement of the handle relative to the housing, and that is disengageable from the housing to enable movement of the handle relative to the housing, and a lock to prevent movement of the handle relative to the housing. In a preferred embodiment, the valve comprises a gear rack attached to a piston, a gear meshed with the gear rack, and a handle to turn the gear, with the use of a gear and rack requiring minimal turning of the handle to achieve the requisite piston stroke to achieve sampling. Thus, by changing the gear pitch diameter, it might only be necessary to turn the handle by one-quarter or one-half turn to fully open the valve, which is at least thirty times faster than the fifteen handle rotations of the prior art mentioned above. The gear pitch diameter can also be increased to control the piston stroke, which allows an operator to modify the sampling characteristic and ability by simply changing a gear. A standard gear housing designed to work with several different pitch diameter gears will allow easier field retrofits in changing piston stroke.

### BRIEF DESCRIPTION OF THE DRAWINGS

FIG. 1 is a top perspective view of one embodiment of a valve of the present invention in the closed position.

FIG. 2 is a top view of valve of FIG. 1.

FIG. 3 is a side view of the valve of FIG. 1 in the open position.

FIG. 4 is a top view of the valve of FIG. 1 in the open position.

FIG. 5 is a sectional view taken through line 5-5 of FIG. 2.

FIG. 6 is a sectional view taken through line 6-6 of FIG. 4.

FIG. 7 is a sectional view taken through line 7-7 of FIG. 2.

FIG. 8 illustrates a handle release of the valve of the present invention.

FIG. 9 illustrates an alternative handle release of the valve of the present invention.

FIG. 10 is a top perspective view of an alternative embodiment of a valve of the present invention.

FIG. 11 is a top perspective view of the valve of FIG. 10 in an intermediate, partially closed position.

FIG. 12 is a top view of the valve of FIG. 10.

FIG. 13 is a sectional view taken through line 13-13 of FIG. 12.

FIG. 14 is a close-up view taken around circle 14 of FIG. 13.

FIG. 15 is a top view of the valve of FIG. 11.

FIG. 16 is a sectional view taken through line 16-16 of FIG. 15.

FIG. 17 is a sectional view taken through line 17-17 of FIG. 15.

### DETAILED DESCRIPTION OF THE PREFERRED EMBODIMENTS

This disclosure describes the best mode or modes of practicing the invention as presently contemplated. This description is not intended to be understood in a limiting sense, but provides an example of the invention presented solely for illustrative purposes by reference to the accompanying drawings to advise one of ordinary skill in the art of the advantages and construction of the invention. In the various views of the drawings, like reference characters designate like or similar parts.

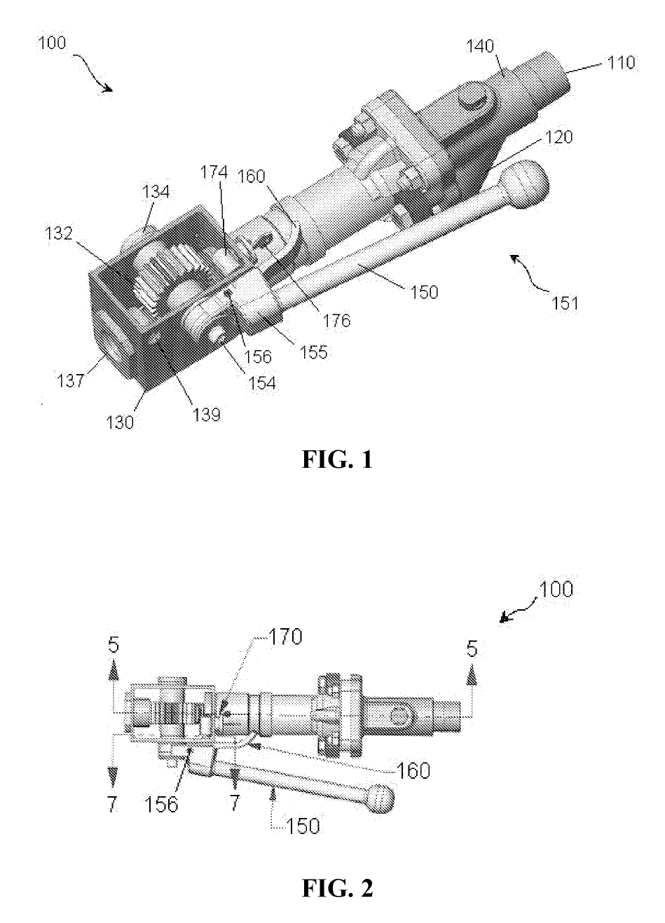

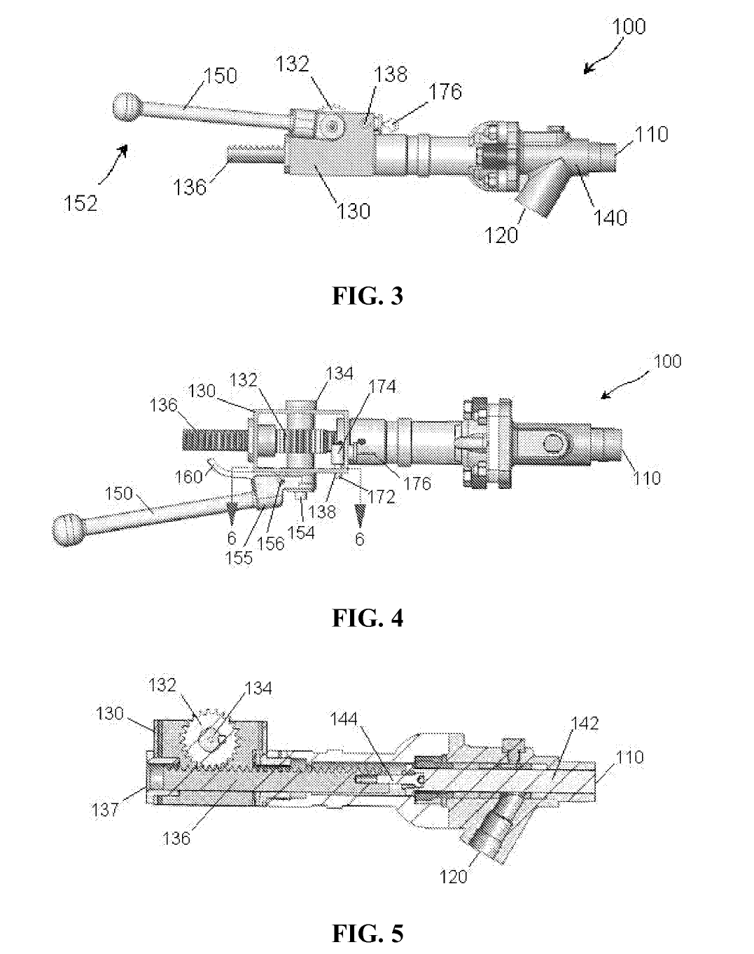

FIG. 1 is a top perspective view of one embodiment of a valve 100 in the closed position. FIG. 2 is a top view of valve 100 of FIG. 1, and FIGS. 3 and 4 are side and top views respectively of valve 100 in the open position. Valve 100 further comprises an inlet 110, an outlet 120, a gear housing 130 having a gear 132 mounted therein, a piston valve housing 140, a handle 150, a handle release 160, and a lock 170. The inlet 110 is introduced into an environment to be sampled (not shown), while a sampling container (not shown) is attached to the outlet 120 for receiving a sample of material present in such environment as is known in the art. Sampled material flows from the inlet 110 to the outlet 120 when the handle 150 is moved from a first position 151 (FIG. 1) with the valve 100 being in the closed position (FIGS. 1, 2), to a second position 152 (FIG. 3) traveling clockwise from closed to open as viewed in FIG. 3 with the valve 100 being in the open position (FIGS. 3, 4). Piston 142 (FIG. 5) is in a sealing relationship with the piston valve housing 140 relative to the outlet 120 when the valve 100 is closed. When the valve 100 is open, piston 142 is moved out of a sealing relationship with the outlet 120 to enable sampled material to flow from the inlet 110 to the outlet 120 and into a collection chamber (not shown) attached to the outlet 120.

Gear 132 is mounted to the gear housing 130 by a gear mounting shaft 134, and handle 150 is attached to the gear mounting shaft 134 by a handle mounting bolt 154. Gear 132 meshes with rack 136, which is attached to piston 142 via a piston mounting bolt 144 (FIG. 5). The stroke of the piston 142 is controlled by the movement of the rack 136. Thus, rotation of handle 150 directly translates into rotation of the gear 132, which results in translational movement of the rack 136 and the piston 142 relative to the gear housing 130 and piston valve housing 140. Rack 136 extends through rack bushing 137 (FIGS. 1, 3, 5) in gear housing 130 when the valve 100 is in the open position. The piston stroke dimension can be varied by changing the pitch or pitch diameter of gear 132, which is useful depending on the distance between the inlet 110 and the outlet 120. Furthermore, a standard gear housing designed to work with several different pitch diameter gears will allow easier field retrofits in changing piston stroke.

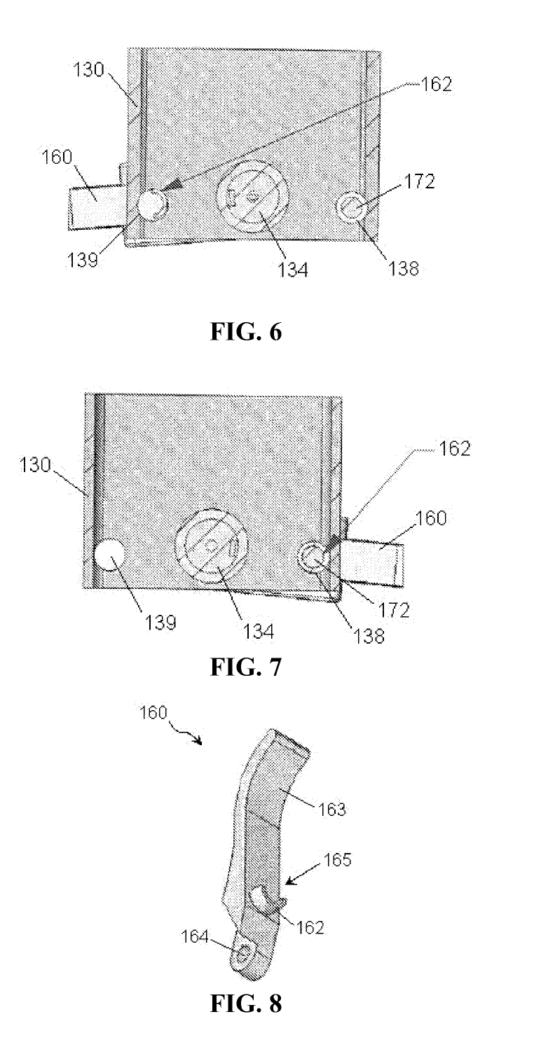

The first (closed) and second (open) positions 151, 152 of handle 150 are preferably controlled and ensured through the engagement of a handle release 160 (FIG. 8) with the gear housing 130. More specifically, the handle release 160 comprises a detent pin 162 that engages with a first opening 138 in gear housing 130 when the handle 150 is in the first, closed position 151 (FIG. 7), and a second opening 139 in gear housing 130 when the handle 150 is in the second, open position 152 (FIG. 6). The first and second openings 138, 139 provide the operator with a definitive understanding of the position of the piston 142 and reduce the possibility for human error in positioning. Handle release 160 further comprises an ergonomic finger engagement section 163 (FIG. 8) and an opening 164 through which extends handle cotter pin 156 (FIG. 1) for attachment of the handle release 160 between the handle 150 and the gear housing 130. Handle release 160 is preferably retractable within an opening in the handle portion 155 and spring-biased toward the gear housing 130 such that when the handle is in the closed position 151 and the detent pin 162 is engaged with opening 138, the handle 150 is prevented from moving. Movement of the handle 150 from the closed position 151 to the open position 152 is initiated by retracting the handle release 160 toward the handle 150 to disengage the detent pin 162 from the opening 138. The finger engagement section 163 is simultaneously and ergonomically gripped with the handle 150 to allow an operator to disengage the handle release 160 and move the handle 150 in one fluid motion. When the handle 150 is moved from the closed to open position, the detent pin 162 freely rides on the face of the gear housing 130. Therefore, the operator does not need to depress the finger engagement section 163 on the handle release 160 during such movement.

Lock 170 (FIG. 2) is preferably integrally mounted to the housing 130 to secure the handle release 160 in engagement with the housing 130 and to securely prevent movement of the handle 150 relative to the housing 130. More specifically, lock 170 is mounted to the housing 130 in a location adjacent to the first opening 138 and further comprises a lock pin 172 that is retractable into and out of a pin housing 174 and through the first opening 138 by a key 176. When the detent pin 162, which is hollow as shown in FIG. 8, is extended through the first opening 138 to engage such opening 138 when the valve 100 is in the closed position, the lock pin 172 is coaxially advanced through the hollow portion 165 of the detent pin 162 to lock the detent pin 162 in place to prevent disengagement of the handle release 160 with the gear housing 130 and to prevent movement of the handle 150. The lock pin 172 extends through the hollow portion 165 of the detent pin 162 by a distance that is sufficient to prevent the handle release 160 from disengaging with the gear housing 130.

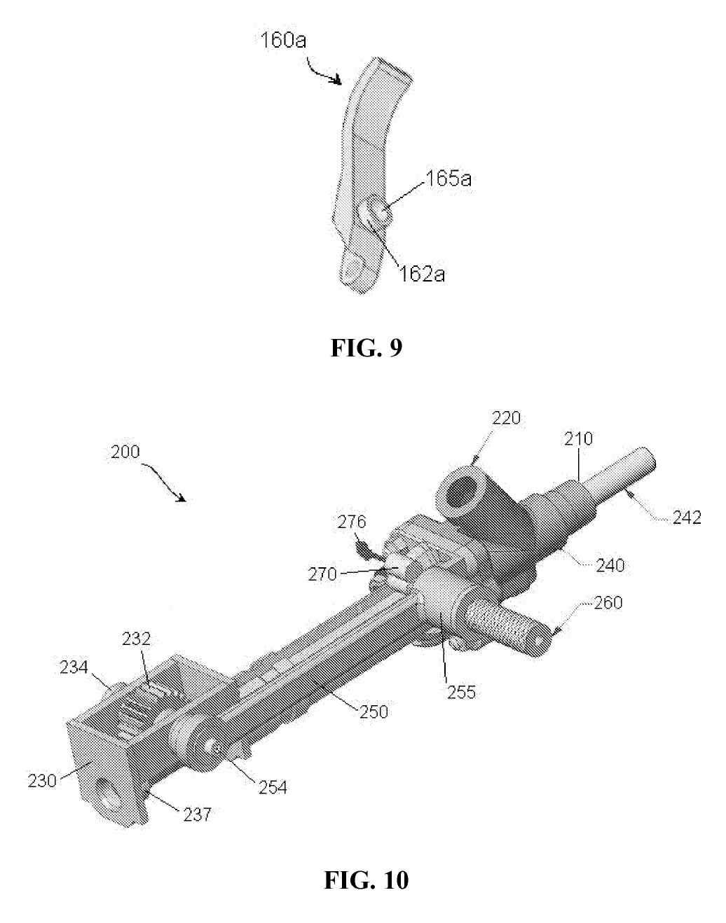

FIG. 8 illustrates a detent pin 162 having an arcuate configuration and an angle of curvature of approximately one hundred and eighty degrees. This configuration allows for slidable engagement with the round openings 138 and 139 in the gear housing 130 and further allows for mating engagement with the cylindrical lock pin 172 as shown in FIG. 7. Of course, the detent pin 162, openings 138, 139 and/or lock pin 172 could be other shapes or configurations without sacrificing their mating relationships. For example, as shown in FIG. 9, the handle release 160a could comprise a detent pin 162a having a continuous, circular configuration with a corresponding hollow portion 165a into which would extend lock pin 172 as discussed above. Other shapes and configurations are contemplated.

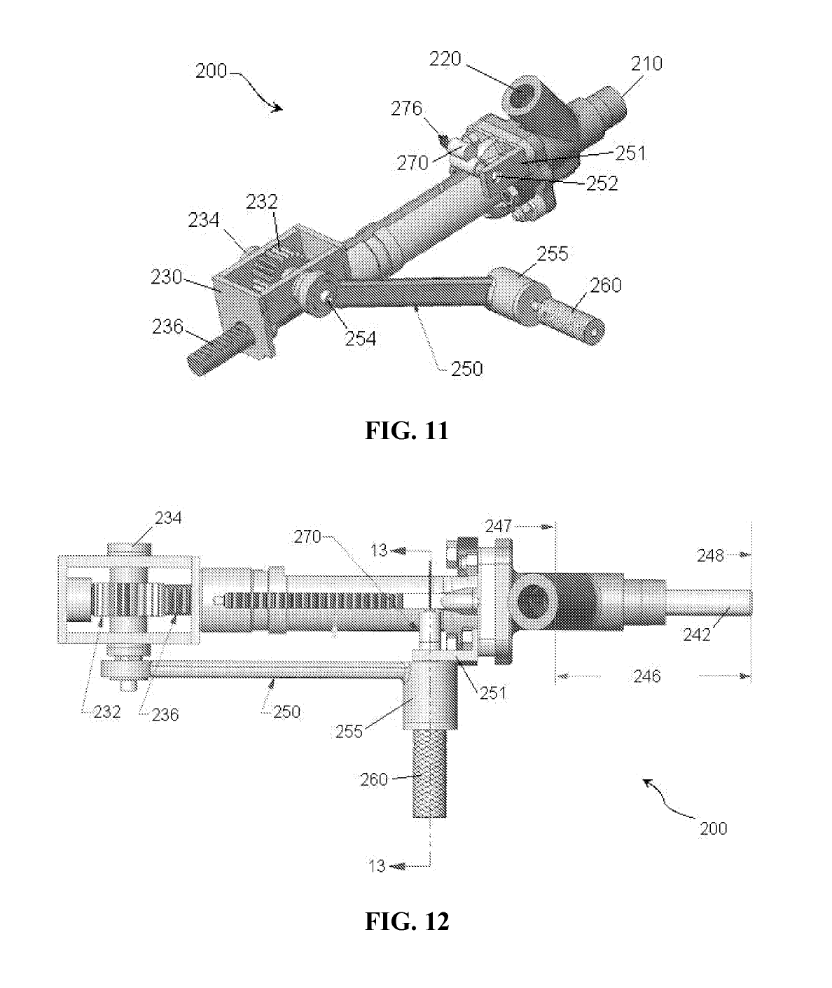

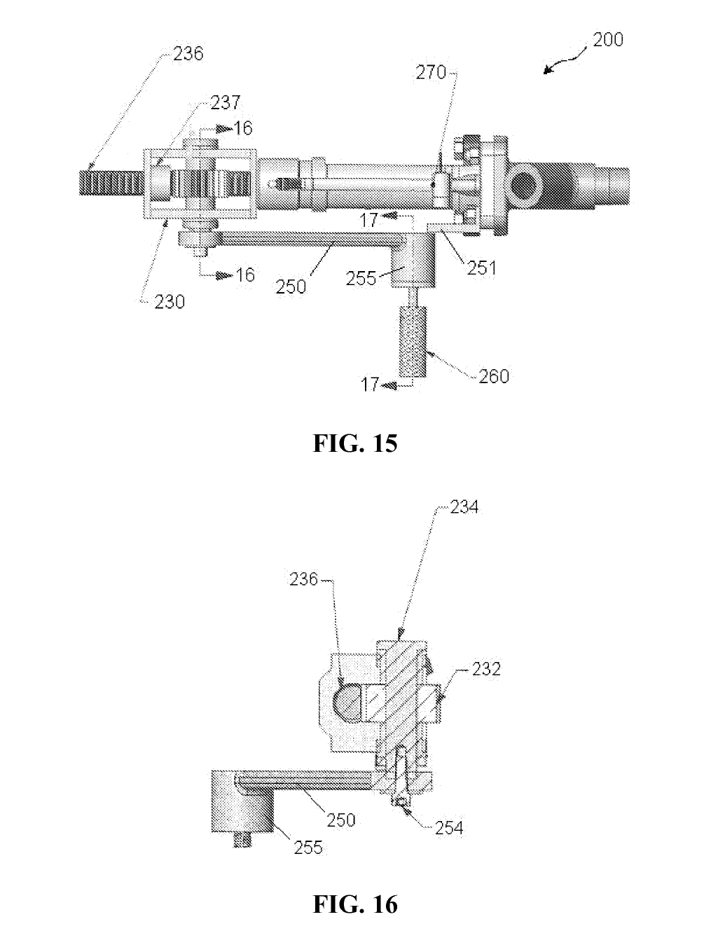

FIG. 10 is a top perspective view and FIG. 12 is a top view of an alternative embodiment of a valve 200 in the open and closed position, while FIG. 11 is a top perspective view and FIG. 15 is a top view of valve 200 in an intermediate, partially closed position. Valve 200 further comprises an inlet 210, an outlet 220, a gear housing 230 having a gear 232 mounted therein, a piston valve housing 240, a handle 250, a grip 260, and a lock 270. Gear 232 is mounted to the gear housing 230 by a gear mounting shaft 234, and handle 250 is attached to the gear mounting shaft 234 by a handle mounting bolt 254. Gear 232 meshes with rack 236, which is supported by a rack bushing 237 and is attached to piston 242 via a piston mounting bolt (not shown). Rotation of handle 250 in the clockwise direction, one complete revolution, directly translates into rotation of the gear 232, which results in translational movement of the rack 236 and the piston 242 relative to the gear housing 230 and piston valve housing 240, to the open position.

The piston stroke 246 (FIG. 12) is defined by an open piston position 247 and a closed piston position 248 and is controlled by the movement of the rack 236 and rotation of the handle 250. The open and closed position 247, 248 of the piston 242 is controlled by positioning the handle 250 relative to a detent plate 251 (FIG. 11) mounted adjacent the piston valve housing 240, the detent plate 251 having an opening 252 that is adapted to receive a detent pin 262 extending from the grip 260 and supported by a pin bushing 255. The piston stroke 246 is realized through a three hundred and sixty degree rotation of the handle 250 such that the open and closed position of the handle relative to the detent plate 251 is the same. The piston stroke dimension can be varied by changing the pitch or pitch diameter of gear 232, which is useful depending on the distance between the inlet 210 and the outlet 220.

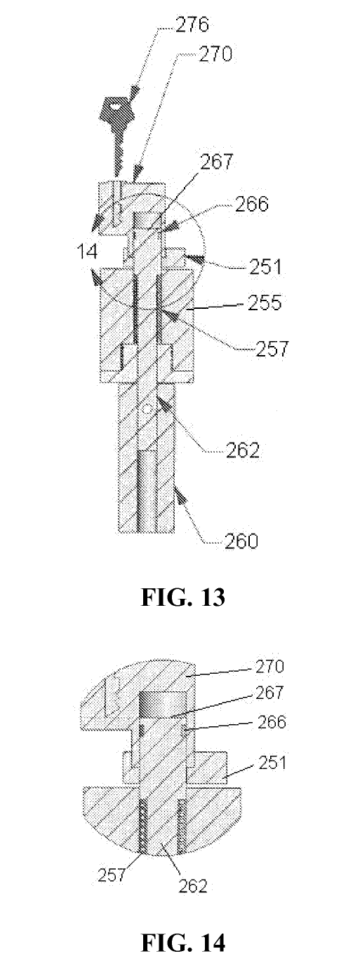

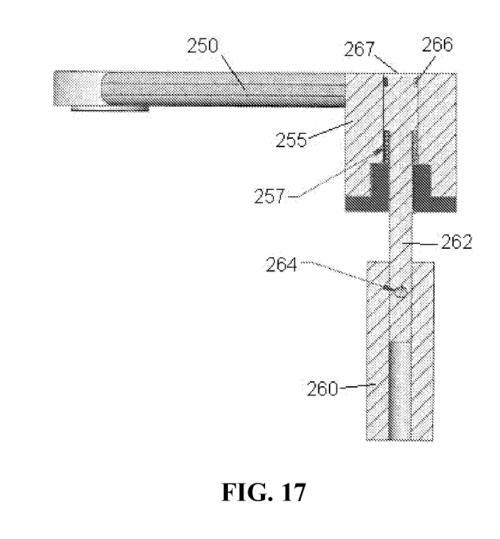

Detent pin 262 is attached to the grip 260 by a grip locking pin 264 (FIG. 17) and further comprises a locking groove 266 on an end 267 (FIG. 17) of the pin 262 opposite the end that is embedded in the grip 260, the locking groove 266 adapted to engage with lock 270 as described below. Grip 260 is retractable relative to the pin bushing 255 by the sliding movement of the detent pin 262 within the pin bushing 255, and grip 260 is biased toward the pin bushing 255 by a spring 257 extending around the detent pin 262. When the grip 260 is retracted relative to the pin bushing 255 as shown in FIG. 17, the spring 257 compresses and the end 267 of the detent pin 262 becomes flush with the end of the pin bushing 255, which allows the handle 250 to move freely relative to the detent plate 251. When the detent pin 262 is aligned with the opening 252 in the detent plate 251 and the grip 260 is released from its retracted state, the detent pin 262 extends through the opening 252 in the detent plate 251 as shown in FIGS. 13 and 14 and engages with lock 270 that is preferably integrally mounted directly to the back of the detent plate 251 or adjacent to the piston valve housing 240. The lock 270 engages the locking groove 266 in the end 276 of the detent pin 262 upon actuation by a key 276, which secures the grip 260 and the handle 250 into engagement with the detent plate 251, prevents retraction of the grip 260, and prevents movement of the handle 250 relative to the detent plate 251 and gear housing 230. The key 276 is engagable with the lock 270 along an axis that is parallel with the axis of engagement of the detent pin 262 with the opening 252 in the detent plate 251 (whereas the key 176 from the embodiment of FIGS. 1-9 is engagable with the lock 170 along an axis that is perpendicular with the axis of engagement of the detent pin 162 with the opening 138 in the gear housing 130).

Sampled material flows from the inlet 210 to the outlet 220 when the handle 250 is rotated from the closed piston position 248 to the open piston position 247 (FIG. 12). Piston 242 is in a sealing relationship with the piston valve housing 240 relative to the outlet 220 when the valve 200 is closed. When the valve 200 is open, piston 242 is moved out of a sealing relationship with the outlet 220 to enable sampled material to flow from the inlet 210 to the outlet 220 and into a collection chamber (not shown) attached to the outlet 220.

The valve embodiment 200 of FIGS. 10-17 illustrates a handle release that is integrated into the grip of the handle and is operated without the need to manipulate a lever that is separate from the handle. Thus, the valve operator can simultaneously pull on the grip 260 and rotate the handle 250 to open or close the valve 200.

When the valve 200 is closed as shown in FIGS. 10 and 12, the rack 236 is retracted within the gear housing 230 and is otherwise hidden from view. However, the rack 236 extends through the rack bushing 237 and outside of the gear housing 230 when the valve 200 is opened or opening as shown in FIGS. 11 and 15. Thus, a valve operator understands that the valve 200 is being opened or is fully opened by the extension of the rack 236 from the gear housing 230. Thus, the rack 236 could, for example, be painted a bright color to further highlight the opened state of the valve 200. Alternatively, for example, the word “OPEN” could be printed on the portion of the rack 236 that extends outside of the gear housing 230. These same features could be incorporated into the valve embodiment of FIGS. 1-9. Other means of communicating the open state of the valve are contemplated.

While the present invention has been described at some length and with some particularity with respect to the several described embodiments, it is not intended that it should be limited to any such particulars or embodiments or any particular embodiment, but it is to be construed with references to the appended claims so as to provide the broadest possible interpretation of such claims in view of the prior art and, therefore, to effectively encompass the intended scope of the invention. Furthermore, the foregoing describes the invention in terms of embodiments foreseen by the inventor for which an enabling description was available, notwithstanding that insubstantial modifications of the invention, not presently foreseen, may nonetheless represent equivalents thereto.

What is claimed is:

1. A valve comprising:
a) a housing;
b) a handle movable from a first position with the valve being closed, to a second position with the valve being open;
c) a handle release that is engagable with the housing to prevent movement of the handle relative to the housing, and that is disengageable from the housing to enable movement of the handle relative to the housing; and
d) a lock for maintaining the handle release engaged with the housing to prevent movement of the handle relative to the housing.

2. The valve of claim 1, the handle release further comprising a retractable member that is movable into and out of engagement with the housing, the lock preventing the retractable member from retracting out of engagement with the housing.

3. The valve of claim 2, the retractable member further comprising a hand grip for the handle.

4. The valve of claim 2, the retractable member being biased into engagement with the housing.

5. The valve of claim 2, the housing further comprising a detent hole and the retractable member further comprises a pin engagable with the detent hole.

6. The valve of claim 1, the handle release further comprising a locking groove for engagement with the lock.

7. The valve of claim 1, the first position and the second position being the same position for the handle relative to the housing.

8. The valve of claim 2, the retractable member being movable into and out of engagement with the housing along an engagement axis, the lock being operated by a key that is engagable with the lock along an axis that is parallel to the engagement axis.

9. The valve of claim 2, the retractable member being movable into and out of engagement with the housing along an engagement axis, the lock being operated by a key that is engagable with the lock along an axis that is perpendicular to the engagement axis.

10. The valve of claim 1, the handle being mounted to a gear that is meshed with a rack, wherein rotational movement of the handle translates into linear movement of the rack that results in the opening and closing of the valve.

11. The valve of claim 1, the lock being integrally mounted to the housing.

12. A valve comprising:
a) a housing;
b) a handle for opening and closing the valve; and
c) a handle release comprising a hollow pin section that is engagable with the housing to prevent movement of the handle relative to the housing, and that is disengageable from the housing to enable movement of the handle relative to the housing.

13. The valve of claim 12, further comprising a lock that coaxially engages the hollow pin section.

14. The valve of claim 13, further comprising an arcuate pin section having a curvature of less than 360 degrees.

15. The valve of claim 12, the hollow pin section further comprising a hollow circular pin section.

16. The valve of claim 12, the lock being integrally mounted to the housing.

17. A valve comprising:
a) a housing;
b) a handle for opening and closing the valve;
c) the handle further comprising a detent pin that is engagable with the housing to prevent movement of the handle relative to the housing, and that is disengageable from the housing to enable movement of the handle relative to the housing; and
d) a lock engagable with the detent pin.

18. The valve of claim 17, the lock being operated by a key that is engagable with the lock along an axis that is parallel to a central axis of the detent pin.

19. The valve of claim 17, the lock being operated by a key that is engagable with the lock along an axis that is perpendicular to a central axis of the detent pin.

20. The valve of claim 17, the lock being integrally mounted to the housing.
